(19) United States
(12) Patent Application Publication
(10) Pub. No.: US 2012/0180308 A1
(43) Pub. Date: Jul. 19, 2012

(54) BATTERY FABRICATION METHOD

(76) Inventors: Nobuhiro Yamada, Toyota-shi (JP); Masataka Takeda, Toyota-shi (JP)

(21) Appl. No.: 13/497,848

(22) PCT Filed: Sep. 28, 2009
(86) PCT No.: PCT/JP2009/004937

§ 371 Date: Mar. 23, 2012

(51) Int. Cl. H01M 4/04

(52) U.S. Cl. 29/623.1

(57) ABSTRACT

Provided is a battery fabrication method capable of collecting foils by reforming a collector with ease and at a high quality. The battery fabrication method is to fabricate a battery (10) including an electrode body (30) formed such that a positive electrode foil (31), a part of the surface of which is coated with a positive electrode mixture, and a negative electrode foil (32), a part of which is coated with a negative electrode mixture, are stacked with a separator (33) interposed therebetween and the stacked foils are rolled. In the processes of the battery fabrication method, when the electrode body (30) is formed by the rolling, the mixture non-coated parts (35, 36) of the positive electrode foil (31) and negative electrode foil (32) are reformed by use of a reforming roll (50, 50), thereby collecting into bundles (35a,36a) a plurality of foils having different rounds in the radial direction of the electrode body (30) at the mixture non-coated parts (35, 36).

### TECHNICAL FIELD

The present invention relates to a method for manufacturing a battery, and particularly to a technique of manufacturing the battery with an electrode body formed as a wound body.

### BACKGROUND ART

A cylindrical lithium-ion secondary battery includes a cylindrical casing and a cylindrical electrode body formed by winding positive and negative electrode sheets and separators as these sheets and separators laminated. The electrode body housed in the casing is submerged in an electrolyte, and it works as a chargeable and dischargeable element.

The casing has electrode terminals at the outside thereof. The terminals are connected to the electrode body via current collecting plates and lead terminals, and the terminals perform as electric paths between the inside of the battery (electrode body) and the outside.

The positive and negative electrode sheets are partially coated with electrode compounds, and the electrode sheets are wound with the compound coated portions overlapping through the separators. The portions of these sheets where the compounds are not coated (non-coated portions) are projected toward the opposite directions each other. The non-coated portions of the sheets are arranged projecting from the each roll end surface of the wound body, and along the radial direction of the wound body, the non-coated portions at the different rounds are arranged in order.

The non-coated portions projecting in the above-described manner perform as current collectors, to which the current collecting plates are connected.

Because the positive and negative electrode sheets are thin metal foils, there are small connecting areas among the current collecting plates and the positive or negative electrode sheet. Therefore, the cylindrical battery has a problem in connection between the current collectors and the current collecting plates.

For instance, JP 2008-258145 A discloses a current collecting plate including slots into which a group of current collectors of the electrode body is inserted. The current collecting plate is welded to the electrode body, with the collecting plate covering the top surface (roll end surface) of the electrode body, in which the gathered collectors are inserted into the slots of the collecting plate. The collecting plate contacts the gathered non-coated portions of the positive or negative electrode sheet, and so, the sheets are bundled in the slots of the collecting plate due to the gravity. The welding is performed on the condition that the multiple non-coated portions are gathered, thereby enlarging the connecting areas and ensuring the connecting strength.

In the technique disclosed in JP 2008-258145 A, the current collectors are bent after winding the electrode sheets to configure the electrode body, so that the sheets may be damaged during the deformation. For example, when the variation occurs in the projecting amounts of the collectors or in the clearances between the adjacent collectors, the troubles may be lead such as damages due to overloads to the sheets and short circuits due to the deformations of the collectors, and thus it's difficult to keep product quality.

### Citation List

### Patent Literature

PTL 1: JP 2008-258145 A

### SUMMARY OF INVENTION

### Technical Problem

The present invention aims to provide a battery manufacturing method capable of gathering sheets by reforming a current collector with ease and at a high quality.

### Technical Solution

The first aspect of the present invention is a method for manufacturing a battery that comprises an electrode body formed by winding a positive electrode sheet partially coated with a positive electrode compound, a negative electrode sheet partially coated with a negative electrode compound and separators, with these sheets and separators laminated. While winding the electrode body, a non-coated portion where the electrode compound is not coated is reformed to gather multiple sheets having different rounds in a radial direction of the electrode body.

In the advantageous embodiment, a reforming roll telescopically moving with respect to the winding core of the electrode body is used for pressing and reforming the non-coated portion cyclically.

More advantageously, the reforming roll telescopically moves in response to the change of thickness of the electrode body accompanied by the winding and to the cycle of reforming.

In the alternative embodiment, the reforming roll is disposed near the winding core to directly press the electrode body during the winding process.

The reforming roll is preferably formed in conical shape having a bottom at the tip side of the non-coated portion.

### Advantageous Effects of Invention

According to the method of the present invention, the electrode sheets are gathered by reforming the current collecting portions with ease and high quality.

### BRIEF DESCRIPTION OF DRAWINGS

FIG. 1 schematically illustrates a battery manufactured by a method in accordance with the present invention.

FIG. 2 illustrates an electrode body included in the battery, (a) is the perspective view, and (b) is the section view.

FIG. 3 illustrates a current collecting plate connected to the electrode body.

FIG. 4 depicts the current collecting plate, (a) is the plan view, and (b) is the enlarged section view along A-A line.

FIG. 5 depicts a connection structure between a current collector of the electrode body and the current collecting plate.

FIG. 6 shows a winding process for winding electrode elements of the electrode body.

FIG. 7 shows a reforming roll pressing the electrode body.

FIG. 8 illustrates a reforming structure of the current collector.

FIG. 9 is a map for controlling the move of the reforming roll.

FIG. 10 shows an embodiment of the reforming roll.

FIG. 11 shows alternative embodiments of the reforming roll.

### DESCRIPTION OF EMBODIMENTS

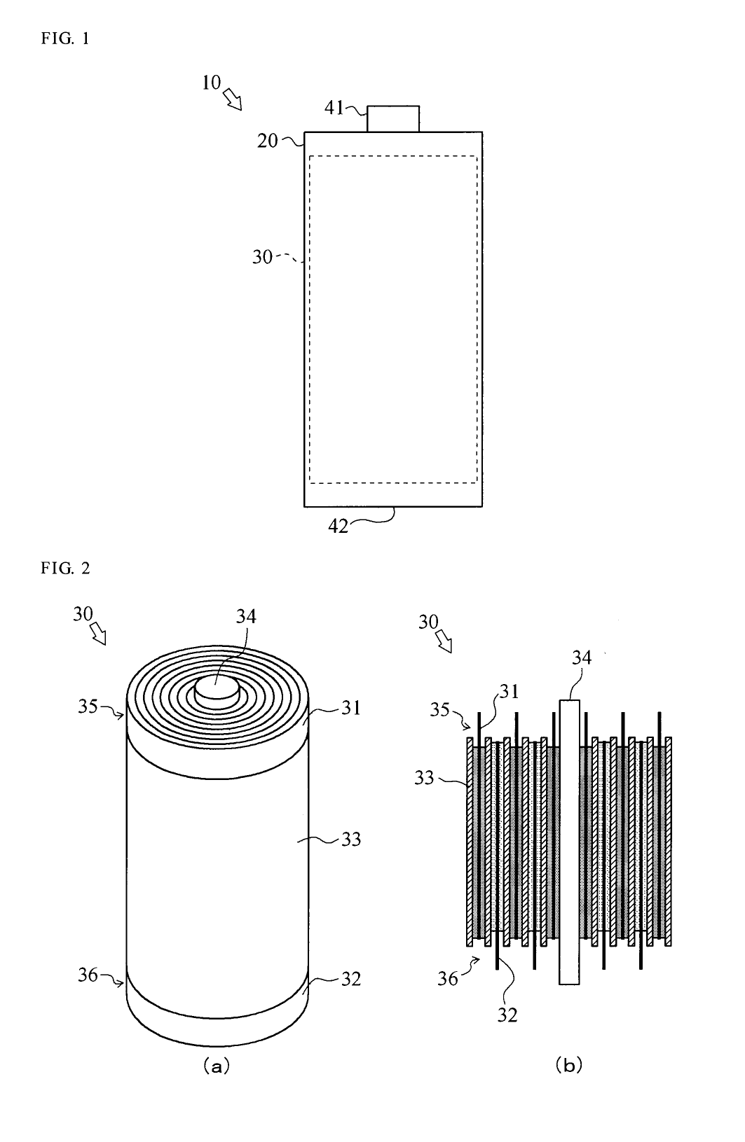

Referring to FIGS. 1 to 3, a structure of a battery 10 is described. The battery 10 is a secondary battery such as a lithium-ion battery, a nickel hydride battery and the like.

As illustrated in FIG. 1, the battery 10 has a cylindrical casing 20 and an electrode body 30 housed in the casing 20. The electrode body 30 is electrically connected to a positive electrode terminal 41 and a negative electrode terminal 42, both of which work as the electric paths between inside and outside of the battery.

The casing 20 is a cylindrical container made of a metal such as aluminum, and houses the electrode body 30. The one end of the casing 20 is formed with the positive electrode terminal 41 projecting toward outwardly, and the other end is formed with the negative electrode terminal 42.

As illustrated in FIG. 2, the electrode body 30 is formed as a cylindrical wound body, in which a positive electrode sheet 31 and a negative electrode sheet 32 are laminated via separators 33 and those are wound around a winding core 34.

The positive electrode sheet 31 is a current collecting sheet made of a metal such as aluminum, and partially coated with a positive electrode compound containing an active material. The negative electrode sheet 32 is a current collecting sheet made of a metal such as copper, and partially coated with a negative electrode compound containing an active material. The separator 33 is a thin film with a number of pores made of polyethylene, polypropylene or polyolefin, and disposed between the positive electrode sheet 31 and the negative electrode sheet 32 to separate them.

The core 34 is made of a resin having insulating property such as polypropylene. The core 34 is formed as a rod and used as the winding core of the electrode body 30.

As shown in FIG. 2(b), the positive electrode sheet 31 and the negative electrode sheet 32 are wound via the separators 33 such that the compound coated portions are overlapped and non-coated portions of compound 35 and 36, i.e. the portions where the compounds are not coated, are projected toward the opposite direction. At one end (upper end in FIG. 2(b)) of the electrode body 30, the non-coated portion 35 comes out multiple times at the different rounds in the radial direction, and at the other end (lower end in FIG. 2(b)) of that, so does the non-coated portion 36.

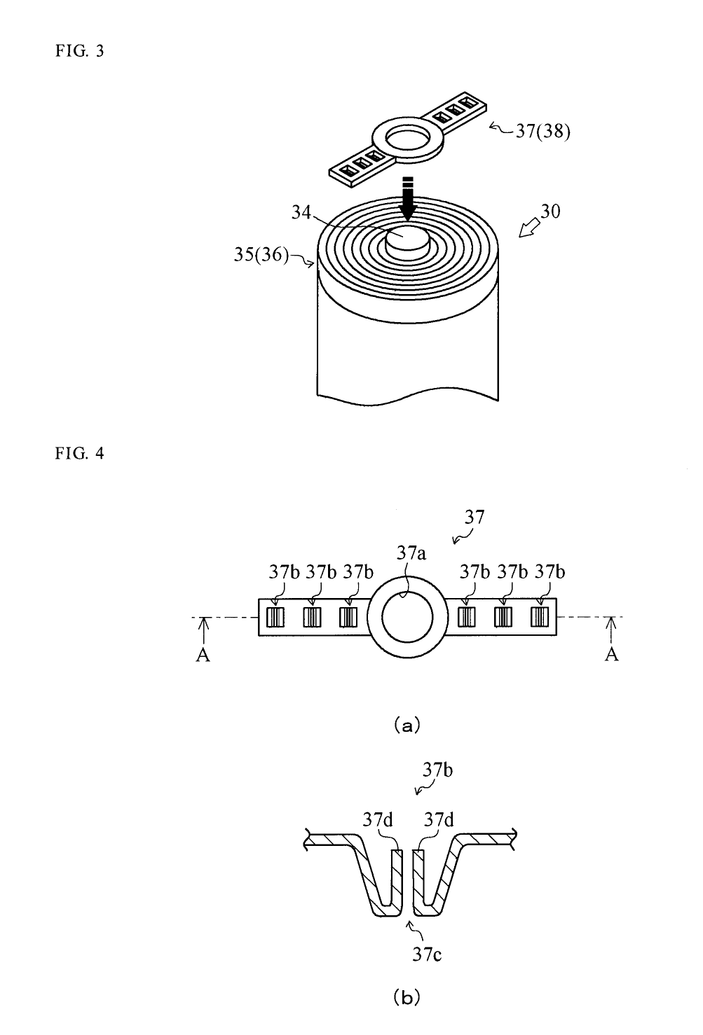

The non-coated portions 35 and 36 work as the current collectors of the electrode sheets 31 and 32, respectively. As illustrated in FIG. 3, the non-coated portions are connected to current collecting plates 37 and 38, respectively. The collecting plates 37 and 38 are connected to the terminals 41 and 42 via lead terminals (no shown), respectively. Thus, the electrode body 30 is electrically connected to the terminals 41 and 42, and thereby the terminals 41 and 42 perform as the electrical paths to the outside of the battery 10.

Referring to FIGS. 3 to 5, a description will be given about structures of the current collecting plates 37 and 38, and connection structures between the collecting plates 37 and 38 and the non-coated portions 35 and 36. In this embodiment, the structures of the collecting plates 37 and 38 are same, and thus the below description will be given to the collecting plate 37 connected to the non-coated portion 35 that is the positive electrode side. The collecting plate 38 connected to the non-coated portion 36 that is the negative electrode side and the connecting structure between the collecting plate 38 and the non-coated portion 36 are not explained.

As depicted in FIGS. 3 and 4(a), the current collecting plate 37 is straight metal plate, and has a through hole 37a and multiple slots 37b (in drawings, from the center, there are three slots along one direction and three slots along the other direction).

The through hole 37a has a diameter larger than the core 34 and disposed at the center of the plate 37. The slots 37b are arranged symmetrically around the through hole 37a.

As shown in FIG. 4(b), the slot 37b includes a straight slit portion 37c and two clip portions 37d forming the slit portion 37c.

The slit portion 37c is configured as a straight opening having a predetermined width, which opens perpendicular to the extending direction of the collecting plate 37 (see FIG. 4(a)).

The clip portions 37d are extended toward one side (lower side in drawings) of the thickness direction of the collecting plate 37, and bent such that the end is directed opposite to the extended direction thereof (upper direction in drawings). That is, the clip portion 37d is bent twice, at the base and the middle.

The above-described structure provides elastic deformations of the clip portions 37d due to the force acted on the clip portions 37d when the member to be inserted between the clip portions 37d has larger width than the width of the slit portion 37c, and the elastic deformations lead the clip force against the force caused by the member inserted into the slit portion 37c.

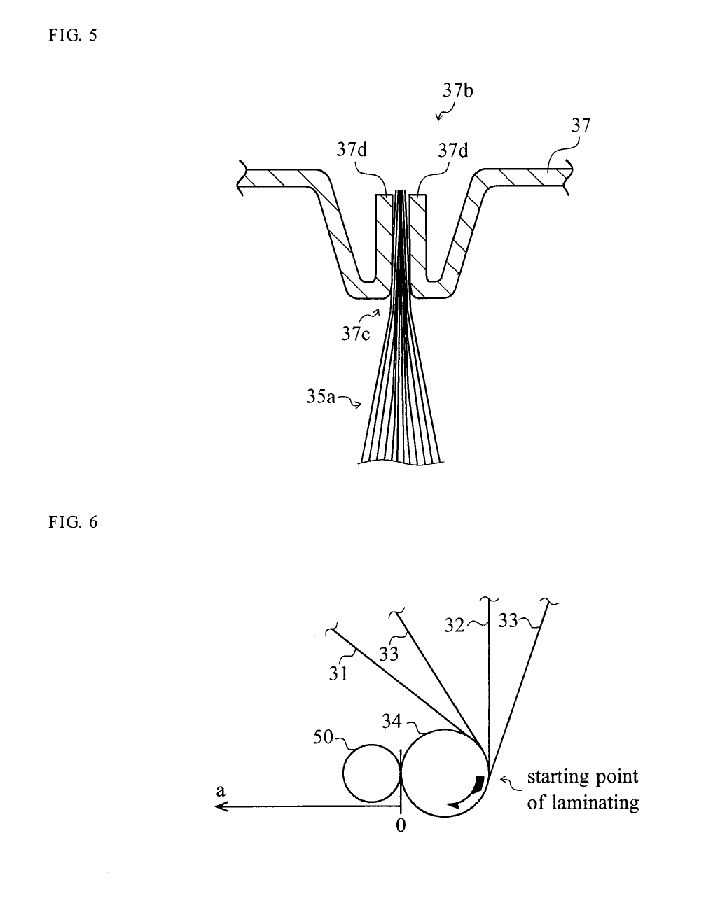

As depicted in FIG. 5, the non-coated portion 35 is gathered into bundles 35a such that the multiple sheets having the different rounds in the radial direction are bundled. The bundle 35a gathered in such manner is inserted into the slit portion 37c. The clip portions 37d apply the clip force to the bundle 35a of the non-coated portion 35 inserted into the slit portion 37c, thereby contacting closely the gathered non-coated portion 35.

The non-coated portion 35 is inserted into the slit portion 37c, i.e. the non-coated portion 35 is fitted into the slots 37b, and the non-coated portion 35 is connected to the current collecting plate 37. The connection is performed by welding, blazing or the like.

As described above, the non-coated portion 35 is gathered into multiple bundles 35a and inserted into the slit portions 37c, thereby enhancing the contact. Therefore, the non-coated portion 35 is connected to the slots 37b without space between rounds.

The number of the slots 37b of the collecting plate 37, to which the non-coated portion 35 is connected, is not limited to six as this embodiment, and the number may be changeable in response to the connecting process, the connection structure to the electrode body 30 or the like.

For instance, if the number of the slots 37b is low, the workability is improved due to the less connecting processes. If the number of the slots 37b is high, the connecting property between the electrode body 30 and the collecting plate 37 is enhanced.

The width of the slit portion 37c of the slot 37b may be set in response to the thickness of the non-coated portion 35 or the like.

As described above, the non-coated portion 35 as the current collector of the electrode body 30 is connected to the current collecting plate 37, with the non-coated portion bundled into multiple bundles 35a. In other words, the process for manufacturing the electrode body 30 needs the bundle process for gathering the non-coated portion 35 into the bundles 35a.

In the conventional method for manufacturing the battery, the bundle process is performed after the winding process of the electrode body. However, when bundling the sheet of the wound electrode body, the sheet may be damaged or tore, so that the bundle process needs high accuracy.

In this embodiment enable to overcome the problems involved in the conventional method, the method for manufacturing the battery includes a winding process for winding the electrode body 30 and bundling the sheets thereof.

Referring to FIGS. 6 to 9, a method for manufacturing the battery 10 is described below.

The manufacturing method for the battery 10 includes the winding process in which the positive electrode sheet 31, the negative electrode sheet 32 and the separators 33, which are the electrode elements constructing the electrode body 30, are laminated and the laminated sheets are wound around the core 34 to configure the electrode body 30, and some subsequent processes such as assembly process for assembling the battery 10 in which the electrode body 30 is housed in the casing 20.

As shown in FIG. 6, in the winding process, from the core 34 (winding center), the positive electrode sheet 31, the separator 33, the negative electrode sheet 32, and the separator 33 are arranged in order, and the ends thereof are fixed to the outer surface of the core 34. The core 34 rotates to form the electrode body 30 wound around the core 34, in which the sheets-fixed point becomes the starting point of laminating the electrode element.

In this process, the electrode elements 31, 32 and 33 are arranged with respect to the axis of the core such that the non-coated portion 35 of the positive electrode sheet 31 and the non-coated portion 36 of the negative electrode sheet 32 are projected to the opposite directions. More specifically, each of the non-coated portions 35 and 36 projects along the axis of the core 34.

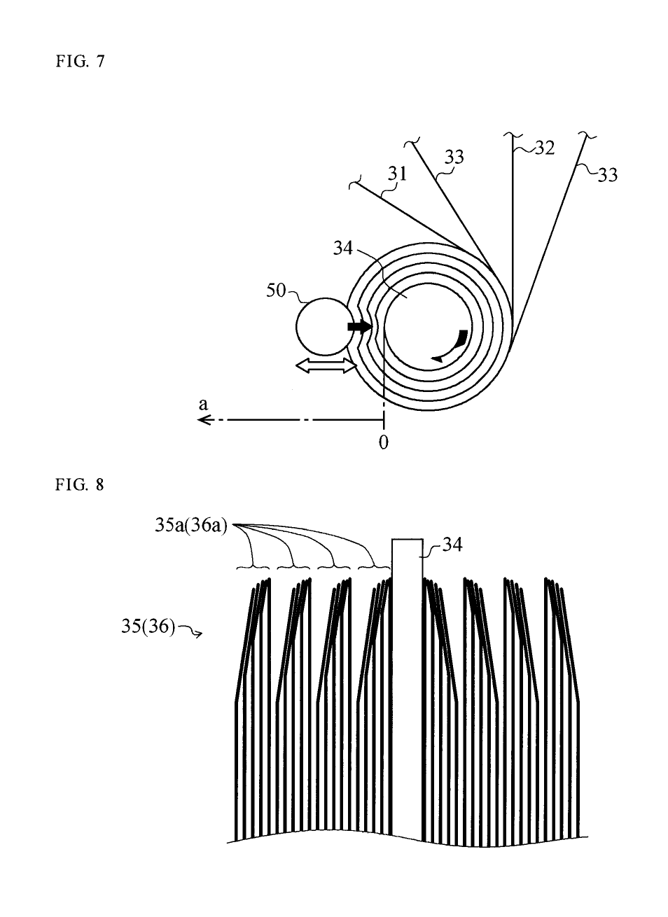

As illustrated in FIGS. 7 and 8, the winding process uses reforming rolls 50 to reform the non-coated portions 35 and 36 while the electrode elements 31, 32 and 33 are wound around the core 34 and to bundle the non-coated portions 35 and 36 into bundles 35a and 36a.

The reforming rolls 50 are positioned near the core 34 and opposite to the laminating starting point of the electrode elements 31, 32 and 33 (the point on the outer periphery of the core 34 where the electrode elements 31, 32 and 33 are fixed). The reforming rolls 50 are movable with respect to the core 34 and along the radial direction of the core 34.

The move of the reforming roll 50 is controlled by the transfer device to move the roll telescopically and the control device to operate the transfer device for controlling the reforming structure.

The forming roll 50 moves with respect to the center of the core 34, thereby contacting the middle portion of the non-coated portion 35 or 36 and pressing the portion toward the core 34 (winding center). Thus, the non-coated portions 35 and 36 are deformed to incline toward the winding center. As described above, the reforming rolls 50 press the non-coated portions 35 and 36 toward the core 34 (winding center), and deform those into the predetermined shape, which is defined as “reform for the non-coated portions 35 and 36” in this embodiment.

As shown in FIG. 8, the non-coated portions 35 and 36 are gathered into bundles 35a and 36a by using the reforming rolls 50. The non-coated portions 35 and 36 are bundled into multiple groups, where each group contains multiple rounds (five rounds in drawings) of sheets counted from the inner side, and the adjacent groups are spaced each other. Due to the telescopic move of the reforming roll 50 to the core 34, the non-coated portion 35 or 36 is pressed and reformed cyclically. As a result, the non-coated portions 35 and 36 are formed with multiple gathered portions having constant cycle (bundles 35a and 36a).

The structures of the bundles 35a and 36a formed in the non-coated portions 35 and 36 are preferably set in accordance with the connecting structure such as the number or shapes of the slots of the current collecting plates 37 and 38, considering the connection stability of the collecting plates 37 and 38.

When winding the electrode elements 31, 32 and 33, the reforming rolls 50 are controlled to move with respect to the core 34 to reform the non-coated portions 35 and 36.

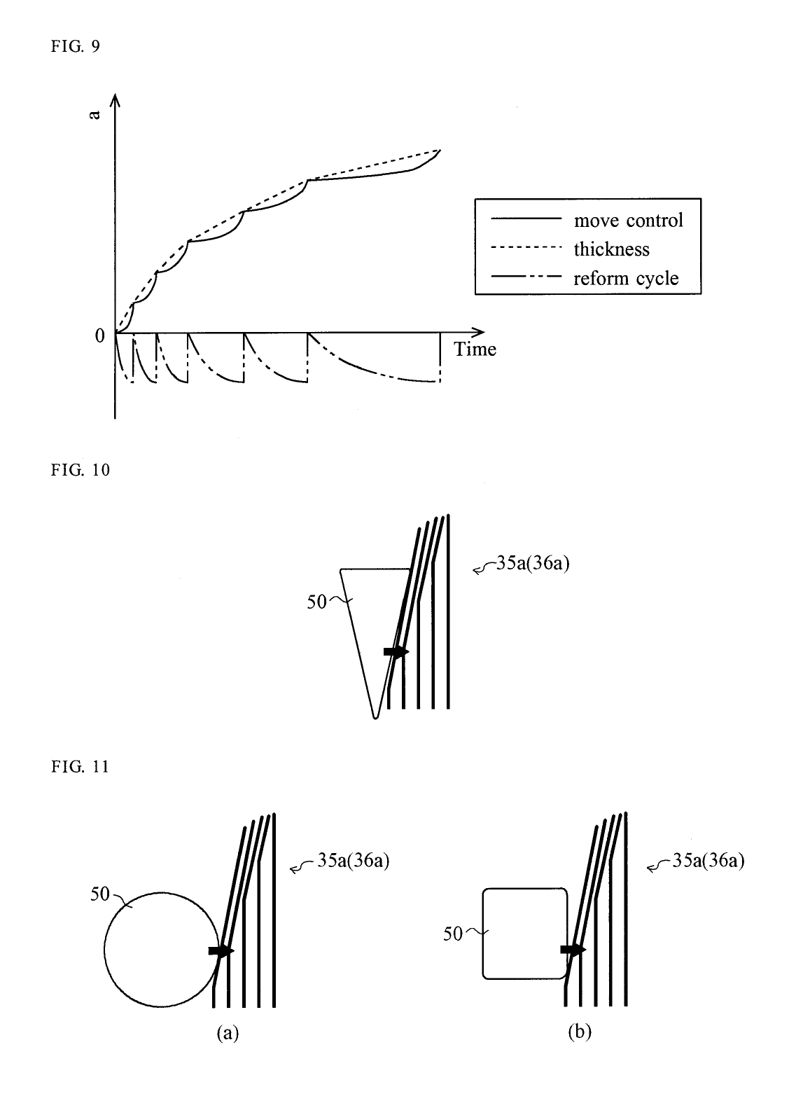

As the electrode elements 31, 32 and 33 are wound, the wound electrode body 30 has bigger diameter shown in broken line in FIG. 9. In order to reform the non-coated portions 35 and 36 into the desired shapes, the reforming rolls 50 are needed to contact and press the non-coated portions 35 and 36 as shown in dashed double-dotted line in FIG. 9.

As described above, FIG. 9 shows the control of reforming roll 50 in view of the diameter change of the electrode body 30 (shown in solid line in FIG. 9). When the outer surface of the core 34 facing the roll 50 is defined as zero point and the distance between the roll 50 and the zero point is defined as a distance (a), the distance (a) is controlled to satisfy the relationship between the time change of the diameter accompanied by the winding (the time change of the distance between the outer surface of the wound body and the core 34) and that of the reform cycle.

In the winding process in this embodiment, the electrode elements 31, 32 and 33 are laminated and wound, and at the same time, the non-coated portions 35 and 36 are bundled.

Therefore, there is no bundle process after the winding process, and the sheets can be bundled without having influence from the production error of the bundles or the error of winding.

As a result, the electrode sheets are gathered by reforming the current collectors, that is the non-coated portions 35 and 36, with ease and at a high quality.

Moreover, in the reforming roll 50, the distance (a) between the roll and the core 34 is controlled in response to the change of the wound thickness of the electrode body 30.

The reforming structures of the non-coated portions 35 and 36 are easily controlled with high quality.

Therefore, the connection quality between the non-coated portions 35 and 36 and the current collecting plates 37 and 38 are enhanced and the battery 10 is provided with high product quality.

The reforming rolls 50 telescopically move in the radial direction with respect to the outer surface of the core 34. That is, the rolls 50 are disposed near the core 34, and the rolls can directly press and deform the non-coated portions 35 and 36 during the winding process.

Thus, the rolls 50 continuously press the portion of the group of the gathered sheets at the same point in the different rounds, and the non-coated portions 35 and 36 contained in the group are unfailingly pressed, thereby improving the accuracy of reforming.

The alternative embodiment of the reforming roll 50 may be disposed apart from the core 34 and contact the non-coated portions 35 and 36 of the electrode elements 31 and 32 before they reach the core 34. In this embodiment, the reforming direction can be not only core side but also the opposite side.

As shown in FIG. 10, the reforming rolls 50 have conical shape whose bottom is at the tip side of the non-coated portions 35 and 36. The reforming rolls 50 are formed in the conical or circular truncated cone shape tapered from the center side to the tip side of the non-coated portions 35 and 36, and the pressures acted to the tips of the non-coated portions 35 and 36 are larger than those acted on the center side.

Due to the configuration, the non-coated portions 35 and 36 are naturally bent, thereby reducing the force acted on the compound coated portions of positive and negative electrode sheets 31 and 32. Therefore, the current collectors of the electrode body 30 are bundles with high quality.

The other embodiment of the reforming roll 50 considering the productivity thereof is shown in FIG. 11. FIG. 11(a) shows the spherical shape, and FIG. 11(b) shows columnar shape. The shape of the reforming roll can be applicable to the shape enable to press the non-coated portions 35 and 36 in the radial direction during the winding process.

In this embodiment, considering the productivity in the winding process, the positive electrode sheet 31, the negative electrode sheet 32, and the separators 33 are laminated and wound around the core 34 in one process. However, the laminating process for laminating the positive electrode sheet 31, the negative electrode sheet 32, and the separators 33 may be separated from the winding process for winding the laminated sheets around the core 34. In this case, the laminating can be operated with high accuracy.

The reforming rolls 50 may be disposed upstream side of the core 34. In this case, the rolls can reform the sheets toward both sides of closing and separating with respect to the core 34. Such arrangement makes the desired reforming easy.

### INDUSTRIAL APPLICABILITY

The present invention is applicable to the method for manufacturing a cylindrical battery, and particularly to the bundling method for bundling the current collectors of the electrode body by reforming the collectors with high accuracy.

1. A method of manufacturing a battery comprising an electrode body formed by winding a positive electrode sheet partially coated with a positive electrode compound, a negative electrode sheet partially coated with a negative electrode compound and separators, with these sheets and separators laminated,
wherein while winding the electrode body, a non-coated portion where the electrode compound is not coated is reformed by a pressure toward a winding core side to gather multiple sheets having different rounds in a radial direction of the electrode body.

2. The method according to claim 1,
wherein a reforming roll telescopically moving with respect to the winding core of the electrode body is used for pressing and reforming the non-coated portion cyclically.

3. The method according to claim 2,
wherein the reforming roll telescopically moves in response to the change of thickness of the electrode body accompanied by the winding and to the cycle of reforming.

4. The method according to claim 2,
wherein the reforming roll is disposed near the winding core to directly press the electrode body during the winding process.

5. The method according to claim 2,
wherein the reforming roll is formed in conical shape having a bottom at the tip side of the non-coated portion.
